(19) United States
(12) Patent Application Publication
(10) Pub. No.: US 2019/0363410 A1
(43) Pub. Date: Nov. 28, 2019

(54) EXTERNALLY-COOLED BATTERY HOUSING

(71) Applicant: Microsoft Technology Licensing, LLC, Redmond, WA (US)

(72) Inventors: John Joseph SIEGLER, Carnation, WA (US); Shaun L. HARRIS, Burton, WA (US); Robert Jason LANKSTON, II, Woodinville, WA (US); Brandon Aaron RUBENSTEIN, Issaquah, WA (US); Michael Geoffrey TRICKER, Boise, ID (US)

(21) Appl. No.: 15/989,519

(22) Filed: May 25, 2018

(51) Int. Cl. H01M 10/6556; H01M 2/10; H01M 6/50; H01M 10/613

(52) U.S. Cl. CPC H01M 10/6556; H01M 10/613; H01M 6/5038; H01M 2/1016

(57) ABSTRACT

A system includes a battery, a thermally-conductive element in thermal communication with the battery, a housing defining an internal volume, the internal volume including the battery and a first end of the thermally-conductive element, and a heat dissipation unit disposed outside of the internal volume, where a second end of the thermally-conductive element is disposed outside of the internal volume and is in thermal communication with the heat dissipation unit.

### BACKGROUND

The electrical components of modern computing systems generate significant amounts of heat. Overheating of the components may compromise their performance and/or cause damage thereto. Computing systems therefore typically employ systems for cooling their constituent electrical components.

For example, a power supply including a battery may be deployed within a data center. In many deployment scenarios, the battery is surrounded by channels of hot air. The hot air increases the temperature of the battery and thereby decreases the operational life of the battery.

In order to alleviate the above-described conditions, conventional systems may use baffling to direct cool air around a battery. However, such approaches are insufficient to cool a battery which resides in a power supply that is in turn inside a server chassis and surrounded by heat-producing entities. Other approaches include the use of fans within the battery housing. Fans decrease reliability and increase cost, and also exhibit limited effectiveness under most conditions due to the potential number of thermal emitters and configurations.

### BRIEF DESCRIPTION OF THE DRAWINGS

FIG. 1 is a block diagram of a system according to some embodiments.

FIG. 2 is a perspective view of a system according to some embodiments.

FIG. 3 is a perspective view of a system according to some embodiments.

FIG. 4 is a perspective view of a power supply chassis including a system according to some embodiments.

FIG. 5 is a top view of blade server components coupled to a power supply according to some embodiments.

FIG. 6 is a perspective view of a network rack including power supplies implementing systems according to some embodiments.

FIG. 7 is flow diagram of a process to manufacture a system according to some embodiments.

### DETAILED DESCRIPTION

The following description is provided to enable any person in the art to make and use the described embodiments. Various modifications, however, will remain readily-apparent to those in the art.

Some embodiments may provide efficient and cost-effective cooling of batteries in a computing architecture. This cooling may also reduce a need to route cool air around batteries in a computing architecture. By reducing this need, a given battery may be placed in a smaller volume, or more/larger batteries may be placed in a same volume, as compared to prior designs.

Generally, some embodiments provide a battery, one or more thermally-conductive elements having first ends in thermal communication with the battery, and a housing which includes the battery and the first ends of the thermally-conductive element(s). A heat dissipation unit is disposed outside of the internal volume, and second ends of the thermally-conductive element(s) are in thermal communication with the heat dissipation unit. This arrangement may provide efficient cooling of the battery, particularly if the battery and housing are disposed in a hot location.

In some embodiments, a thermally-insulating material coupled to the housing surrounds the battery within the internal volume and the housing is sealed. By insulating and sealing the housing, heat within the housing may be efficiently conducted out of the housing, via the thermally-conductive elements, to a heat dissipation unit placed in a cooler location.

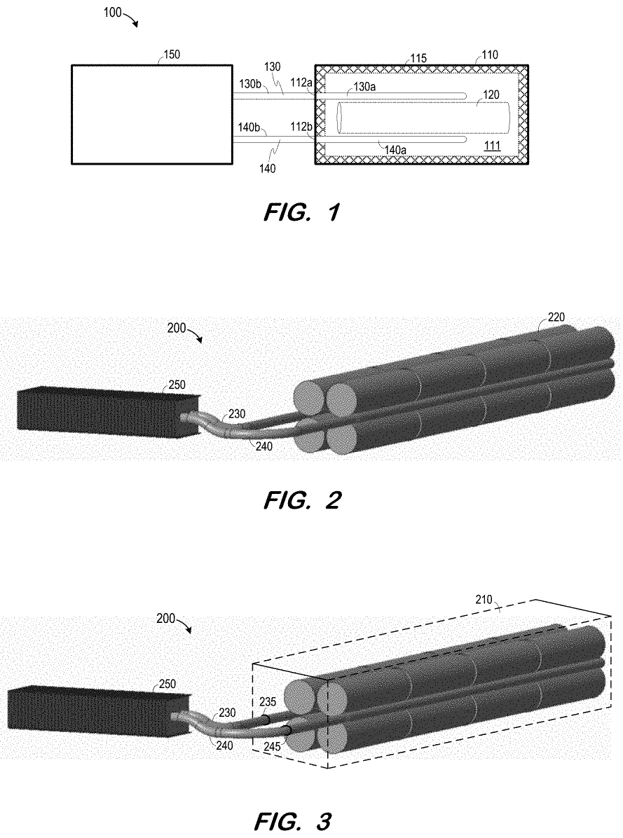

FIG. 1 illustrates system 100 according to some embodiments. Embodiments are not limited to the configuration illustrated in FIG. 1. System 100 includes housing 110, battery 120, thermally-conductive elements 130 and 140, and heat dissipation unit 150. Housing 110 defines internal volume 111, and battery 120 resides within internal volume 111. First ends 130a and 140a of thermally-conductive elements 130 and 140 also reside within internal volume 111 and are in thermal communication with battery 120. Second ends 130b and 140b of thermally-conductive elements 130 and 140 are in thermal communication with heat dissipation unit 150.

Battery 120 may comprise any self-contained power source that is or becomes known. Non-exhaustive examples of battery 120 include disposable alkaline batteries, and rechargeable lead-acid or lithium-ion batteries. Battery 120 is not limited to the illustrated shape. Housing 110 may include more than one battery of one or more types according to some embodiments. For example, housing 110 may include two or more series-connected lithium-ion batteries. Housing 110 also incorporates passive and/or active electrical components (not shown) for connecting the battery or batteries housed within to external circuitry.

Some embodiments may include one or more thermally-conductive elements in thermal communication with one or more batteries disposed within a housing. The one or more thermally-conductive elements are not limited to the illustrated shapes and physical arrangement relative to battery 120. System 100 may include thermally-conductive material placed between battery 120 and first ends 130a and 140a in order to facilitate heat transfer therebetween. The one or more thermally-conductive elements may be composed of any one or more thermally-conductive materials in some embodiments. In some embodiments, one or both of thermally-conductive elements 130 and 140 comprises solid copper or aluminum.

According to some embodiments, one or both of thermally-conductive elements 130 and 140 is a heat pipe which defines at least one internal passage containing a working fluid (e.g., Freon). In one example of operation, first end 130a absorbs heat from internal volume 111 and the heat is transferred to the working fluid therein. The heat causes the fluid to change state from liquid to vapor, which travels along element 130 into second end 130b and to a cold interface between second end 130b and heat dissipation unit 150. The vapor condenses back into a liquid at the cold interface, thereby releasing latent heat. The liquid then returns to first end 130a through capillary action, centrifugal force, or gravity, and the cycle repeats. The working fluid mass is selected so that element 130 contains both vapor and liquid over the operating temperature range.

Heat dissipation unit 150 may comprise any type of types of heat exchanger that are or become known. Examples include, but are not limited to, a passive heat sink comprised of a stack of thin thermally-conductive sheets which transfers the heat generated by an electronic or a mechanical device to a fluid medium, such as air or a liquid coolant. Heat dissipation unit 150 may itself be actively or passively cooled with cool air, liquid, or any other suitable system.

Housing 110 is lined with thermally-insulating material 115 according to some embodiments. Material 115 may assist with preventing heat from entering internal volume 111 and thereby reducing an amount heat to be removed from volume 111. Material 115 may comprise styrofoam in some embodiments. Housing 110 may also be thermally-sealed to further prevent heat from entering volume 111. Such sealing may comprise applying thermal sealant to any seams or openings in housing 110 and material 115, and sealing openings 112a and 112b through which elements 130 and 140 pass. In contrast, conventional battery housings are not insulated or thermally-sealed due to the heat dissipated by charging and discharging of battery 120.

FIGS. 2 and 3 are views of system 200 according to some embodiments. System 200 may comprise an implementation of system 100 but embodiments are not limited thereto. FIG. 2 illustrates system 200 without housing 210 while FIG. 3 illustrates system 200 with a transparent view of housing 200.

System 200 includes housing 210 and batteries 220. Batteries 220 comprise sixteen series-connected batteries. Embodiments are not limited to the number or physical arrangement of batteries shown in FIGS. 2 and 3. Thermally-conductive elements 230 and 240 are coupled to batteries 220 and to heat dissipation unit 250. More specifically, first ends of thermally-conductive elements 230 and 240 are in thermal communication with batteries 220 and second ends of thermally-conductive elements 130 and 140 are in thermal communication with heat dissipation unit 250. FIG. 3 further shows openings 235 and 245 of housing 210, through which elements 230 and 240 respectively pass and which may be thermally-sealed as described above.

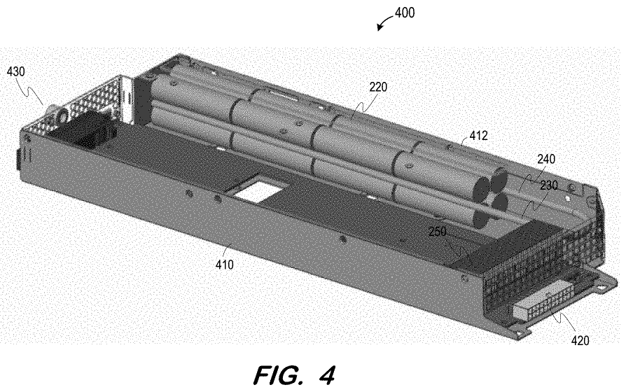

FIG. 4 is a perspective view of system 400 according to some embodiments. System 400 includes power supply chassis 410, in which are mounted batteries 220 and heat dissipation unit 250 from FIGS. 2 and 3. Housing 210 is omitted for clarity.

Power supply chassis 410 may be composed of aluminum and/or any other suitable material. Chassis 410 supports power connector 420 to provide power to external components such as, for example, a rack-mounted server. Chassis 430 also supports power input connector 430 to receive power from an external source such as, for example, mains power. Power supply chassis 410 may also support unshown components which provide power supply functionality as is known in the art. Such functionality may include, but is not limited to, power conditioning, battery recharging, selective switching between mains power and battery power, etc.

As shown, batteries 220 (and unshown housing 210) are disposed adjacent to wall 412 of chassis 410. This position may limit the ability to introduce cooling airflow around housing 210. Moreover, wall 412 may be located in a hot location, thereby causing undesirable heating of batteries 220. As described above, some embodiments may efficiently alleviate this heating using thermally-conducive elements 230 and 240 coupled to heat dissipation unit 250.

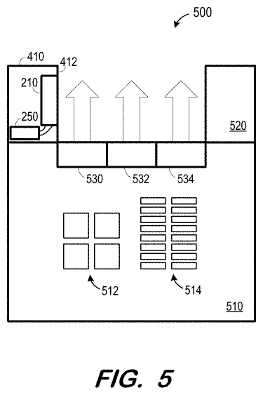

FIG. 5 illustrates system 500 including chassis 410 according to some embodiments. System 500 includes blade server 510 to which chassis 410 is coupled for supplying power thereto. Blade server 510 of system 500 includes processors 512 and memory modules 514, each of which may generate heat during operation. Fans 530, 532 and 534 draw this heat away from these components and into an open area which is adjacent to wall 412 of chassis 410. Accordingly, heat may be transferred from this hot area, through wall 412, and into housing 210. Embodiments may operate to limit the heating of housing 210 (e.g., by thermally-insulating and/or sealing housing 210) and to the internal volume of housing 210 (e.g., via the thermally-conductive elements disposed therein and coupled to heat dissipation unit 250).

Blade server 510 may include many additional heat-generating and/or heat-dissipating components. Network interface 520 is coupled to blade server 510, and any other suitable components may also be coupled thereto. Embodiments are not limited to use in a power supply, or in a power supply which provides power to a blade server.

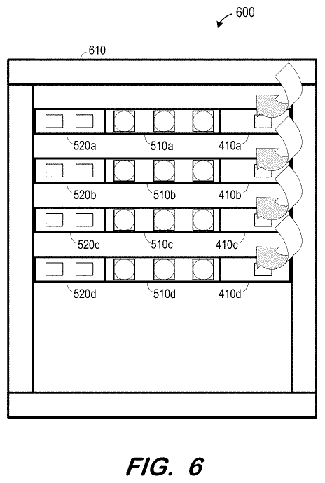

FIG. 6 illustrates system 600 according to some embodiments. System 600 is an example of several blade servers 510a through 510d mounted in a network rack 610. Each of blade servers 510a through 510d is connected to a respective network interface 520a through 520d and power supply chassis 410a through 410d. Network rack 610 may support additional networking components in some implementations, including but not limited to a top-of-rack switch.

As shown, a gap exists above each power supply chassis 410a through 410d. In some embodiments, cool air may be introduced into these gaps in order to cool the heat dissipation units of each power supply chassis 410a through 410d. The cool air may be introduced via baffling, fans, and any other devices deemed suitable. Cooling the heat dissipation units which receive heat from inside their respective battery housings in this manner may provide a more practical and effective cooling solution than attempting to direct cool air to the housings themselves.

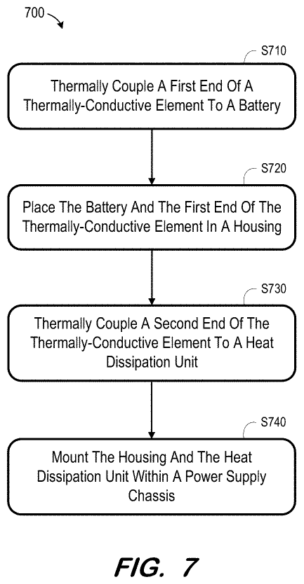

FIG. 7 is a flow diagram of process 700 to manufacture a system according to some embodiments. Initially, at S710, a first end of a thermally-conductive element is coupled to a battery. The battery and the thermally-conductive element may comprise any of the examples thereof mentioned above. In some embodiments, thermally coupling at S710 may simply comprise attaching the element to the battery by any means, including a clip, a stand-off, a tie, a connector, etc. According to some embodiments, a thermal coupling material, such as a thermally-conductive adhesive, is used to physically join the first end of the thermally-conductive element to the battery.

Next, at S720, the battery and the first end of the thermally-conductive element are placed in a housing. The housing may comprise a thermally-insulated container fabricated of any suitable material. Because the thermally-conductive element will extend out from the housing, the housing will include an opening through which the element may pass. In some embodiments, S710 and S720 may be reversed, with the battery being placed in the housing first, and the element then being passed through the housing and thermally-coupled to the battery.

A second end of the thermally-conductive element is thermally coupled to a heat dissipation unit at S730. The heat dissipation unit may comprise any heat dissipation unit that is or becomes known, including but not limited to the examples thereof provided herein. Thermal coupling may incorporate brazing, press-fit connectors, thermal adhesive, or any other coupling mechanisms and/or techniques deemed suitable.

The housing and the heat dissipation unit may be mounted in a power supply chassis at S740, but uses of the inventive apparatus are not limited thereto. Mounting of the housing and the heat dissipation unit in the power supply chassis may also proceed in any suitable manner. In some embodiments, the heat dissipation unit is mounted in a location that may facilitate the cooling thereof when the power supply is deployed in a network architecture.

The foregoing diagrams represent examples of physical architectures for describing some embodiments, and actual implementations may include more or different components arranged in other manners. Moreover, each physical element, component or device described herein may be implemented by any physical elements, component or devices.

Embodiments described herein are solely for the purpose of illustration. Those in the art will recognize other embodiments may be practiced with modifications and alterations to that described above.

What is claimed is:

1. A system comprising:
a battery;
a thermally-conductive element in thermal communication with the battery;
a housing defining an internal volume, the internal volume including the battery and a first end of the thermally-conductive element; and
a heat dissipation unit disposed outside of the internal volume,
wherein a second end of the thermally-conductive element is disposed outside of the internal volume and is in thermal communication with the heat dissipation unit.

2. A system according to claim 1, wherein the thermally-conductive element defines at least one internal passage, and the system further comprising fluid within the at least one internal passage.

3. A system according to claim 1, wherein the heat dissipation unit is a passive heat sink.

4. A system according to claim 1, further comprising:
a power supply chassis in which are mounted the housing and the heat dissipation unit.

5. A system according to claim 1, further comprising:
one or more other batteries, wherein the thermally-conductive element is in thermal communication with the battery and the one or more other batteries.

6. A system according to claim 5, further comprising:
one or more other thermally-conductive elements, wherein respective first ends of the one or more other thermally-conductive elements are in thermal communication with the battery and the one or more other batteries, and wherein respective second ends of the one or more thermally-conductive elements are in thermal communication with the heat dissipation unit.

7. A system according to claim 1, further comprising:
one or more other thermally-conductive elements, wherein respective first ends of the one or more other thermally-conductive elements are in thermal communication with the battery, and wherein respective second ends of the one or more thermally-conductive elements are in thermal communication with the heat dissipation unit.

8. A system according to claim 7, wherein each of the thermally-conductive element and the one or more other thermally-conductive elements define a respective at least one internal passage, the system further comprising fluid within each of the internal passages.

9. A system according to claim 1, further comprising:
a thermally-insulating material surrounding the internal volume and coupled to the housing.

10. A system according to claim 9, wherein the thermally-insulating material defines a thermally-sealed boundary entirely surrounding the internal volume.

11. A method comprising:
thermally coupling a first end of a thermally-conductive element to a battery;
placing the battery in a housing defining an internal volume, the internal volume including the battery and the first end of the thermally-conductive element; and
thermally coupling a second end of the thermally-conductive element to a heat dissipation unit disposed outside of the internal volume.

12. A method according to claim 11, wherein the thermally-conductive element defines at least one internal passage including a heat transfer fluid.

13. A method according to claim 11, wherein the heat dissipation unit is a passive heat sink.

14. A method according to claim 11, further comprising:
mounting the housing and the heat dissipation unit within a power supply chassis.

15. A method according to claim 11, further comprising:
thermally coupling respective first ends of the thermally-conductive element and the one or more other thermally-conductive elements to the battery and to one or more other batteries; and
thermally coupling respective second ends of the one or more other thermally-conductive elements to the heat dissipation unit.

16. A method according to claim 1, further comprising:
lining the housing with a thermally-insulating material surrounding the internal volume; and
thermally sealing an opening of the housing through which the thermally-conductive element passes through the housing.

17. A system comprising:
a power source;
a thermally-conductive element, a first end of the thermally-conductive element being thermally coupled to the power source;
a housing defining a thermally-insulated internal volume, the power source and the first end of the thermally-conductive element being disposed within the internal volume; and
a heat exchanger disposed outside of the internal volume,
wherein a second end of the thermally-conductive element is disposed outside of the internal volume and is thermally coupled to the heat exchanger.

18. A system according to claim 17, wherein the thermally-conductive element is a heat pipe including a working fluid.

19. A system according to claim 17, further comprising:
a power supply chassis in which the housing and the heat exchanger are mounted; and
a power supply mounted in the power supply chassis.

20. A system according to claim 17, further comprising:
one or more other power sources disposed within the internal volume; and
one or more other thermally-conductive elements,
wherein respective first ends of the one or more other thermally-conductive elements are thermally coupled to at least one of the power source and the one or more other power sources, and
wherein respective second ends of the one or more thermally-conductive elements are thermally coupled to the heat exchanger.
